(19) United States
(12) Patent Application Publication
(10) Pub. No.: US 2025/0341007 A1
(43) Pub. Date: Nov. 6, 2025

(54) METHODS OF GENERATING ELECTRICITY

(71) Applicant: Battelle Energy Alliance, LLC, Idaho Falls, ID (US)

(72) Inventors: Dong Ding, Idaho Falls, ID (US); Hanping Ding, Idaho Falls, ID (US); Wei Wu, Idaho Falls, ID (US); Chao Jiang, Ammon, ID (US)

(21) Appl. No.: 19/268,925

(22) Filed: Jul. 14, 2025

Related U.S. Application Data
(62) Division of application No. 17/309,012, filed on Apr. 13, 2021, now Pat. No. 12,359,327.
(60) Provisional application No. 62/751,969, filed on Oct. 29, 2018.

(51) Int. Cl. C25B 11/053; C25B 1/042; C25B 9/23; C25B 11/091; C25B 13/00; C25B 15/023

(52) U.S. Cl. CPC C25B 11/053; C25B 1/042; C25B 9/23; C25B 11/091; C25B 13/00; C25B 15/023

(57) ABSTRACT

An electrochemical cell comprises a first electrode, a second electrode, and a proton-conducting membrane between the first electrode and the second electrode. The first electrode comprises a layered perovskite having the general formula: DAB₂O_{5+δ}, wherein D consists of two or more lanthanide elements; A consists of one or more of Sr and Ba; B consists of one or more of Co, Fe, Ni, Cu, Zn, Mn, Cr, and Nd; and δ is an oxygen deficit. The second electrode comprises a cermet material including at least one metal and at least one perovskite. Related structures, apparatuses, systems, and methods are also described.

### CROSS-REFERENCE TO RELATED APPLICATIONS

This application is a divisional of U.S. patent application Ser. No. 17/309,012, filed Apr. 13, 2021, which is a national phase entry under 35 U.S.C. § 371 of International Patent Application PCT/US2019/058287, filed Oct. 28, 2019, designating the United States of America and published as International Patent Publication WO 2020/092203 A1 on May 7, 2020, which claims the benefit under Article 8 of the Patent Cooperation Treaty to U.S. Patent Application Ser. No. 62/751,969, filed Oct. 29, 2018, the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

The disclosure, in various embodiments, relates to electrochemical cells for hydrogen gas production and electricity generation, and to related structures, apparatuses, systems, and methods.

### BACKGROUND

Hydrogen (H₂) gas is a clean and effective energy carrier to store renewable and sustainable energies, which can be efficiently converted to electricity through fuel cell technology. H₂ gas production is important to achieving a carbon-neutral energy route. High-temperature electrolysis is a conventional process for H₂ gas production that has several advantages, such as high efficiency, fast electrode kinetics, and relatively less expensive materials. Many electrochemical cells employed for high-temperature electrolysis can also be reversibly operated such that energy storage and electricity generation can be effectuated simultaneously.

High-temperature solid-oxide electrolysis cells (SOEC) are one type of electrochemical cell that has conventionally been employed to produce H₂ gas through H₂O electrolysis. However, high-temperature solid-oxide electrolysis cells can suffer from material degradation and material incompatibilities at the relatively higher operating temperatures (e.g., above 600° C., above 700° C.) typically required thereby.

To achieve H₂ gas production at relatively lower temperatures, protonic ceramic electrolysis cells (PCECs) have been investigated, since the electrolyte material thereof generally exhibits lower ionic diffusion activation energy over conventional oxygen-ion conductors (e.g., YSZ, GDC, etc.). For example, the operating temperature for many PCECs can be as low as 400° C. In addition, PCECs can produce dry H₂ gas, circumventing many problems otherwise associated with purifying humid H₂ gas and/or undesirable steam-based metal oxidation. However, challenges remain in the use of PCECs to produce H₂ gas since the steam-side electrodes thereof generally need to be exposed to highly humid air conditions. If the operating temperature of the PCEC is further decreased, the steam-side electrodes may exhibit significant over-potential as catalytic activity becomes poor.

It would be desirable to have new structures, apparatuses, methods, and systems for producing H₂ gas and generating electricity. It would further be desirable if the new structures, apparatuses, methods, and systems facilitated increased H₂ gas production and electricity generation efficiency, increased operational life, and were relatively inexpensive and simple in operation.

### BRIEF SUMMARY

Embodiments described herein include electrochemical cells for H₂ gas production and electricity generation, as well as related structures, apparatuses, systems, and methods. In some embodiments, an electrochemical cell comprises a first electrode, a second electrode, and a proton-conducting membrane between the first electrode and the second electrode. The first electrode comprises a layered perovskite having the general formula: DAB₂O_{5+δ}, wherein D consists of two or more lanthanide elements; A consists of one or more of Sr and Ba; B consists of one or more of Co, Fe, Ni, Cu, Zn, Mn, Cr, and Nd; and δ is an oxygen deficit. The second electrode comprises a cermet material including at least one metal and at least one perovskite.

In additional embodiments, a system for H₂ gas production and electricity generation comprises source of steam, and an electrochemical apparatus in fluid communication with the source of steam. The electrochemical apparatus comprises a housing structure configured and positioned to receive a steam stream from the source of steam, and an electrochemical cell within an internal chamber of the housing structure. The electrochemical cell comprises an electrode positioned to interact with the steam stream, another electrode, and a proton-conducting membrane between the electrode and the another electrode. The electrode comprises (Pr₁₋ₓLnₓ)(Ba_{y},Sr_{1-y})(Co_{z},Tn_{1-z})O_{5+δ}, wherein Ln is selected from La, Nd, Ce, Pm, Sm, Er, Gd, Dy, Ho, and Yb; Tn is selected from Fe, Ni, Cu, Zn, Mn, Cr, and Nd; 0≤x≤1; 0≤y≤1; 0≤z≤1; and δ is an oxygen deficit. The another electrode comprises a metal/perovskite cermet. The proton-conducting membrane comprises a perovskite having an ionic conductivity greater than or equal to about 10⁻² S/cm at one or more temperatures within a range of from about 400° C. to about 700° C.

In yet additional embodiments, a method of generating electricity comprises introducing steam to an electrochemical cell comprising a first electrode, a second electrode, and a proton-conducting membrane between the first electrode and the second electrode. The first electrode comprises (Pr₁₋ₓLnₓ)(Ba_{y},Sr_{1-y})(Co_{z},Tn_{1-z})O_{5+δ}, wherein Ln is selected from La, Nd, Ce, Pm, Sm, Er, Gd, Dy, Ho, and Yb; Tn is selected from Fe, Ni, Cu, Zn, Mn, Cr, and Nd; 0≤x≤1; 0≤y≤1; 0≤z≤1; and δ is an oxygen deficit. The second electrode comprises a metal/perovskite cermet. A first potential difference is applied between the first electrode and the second electrode of the electrochemical cell to produce H₂ gas from the steam. A second potential difference is applied between the first electrode and the second electrode of the electrochemical cell to generate electricity using the produced H₂ gas as a fuel.

In further embodiments, a structure comprises at least one layered perovskite having the general formula: DAB₂O_{5+δ}, wherein D consists of two or more of La, Ce, Pr, Nd, Pm, Sm, Er, Gd, Tb, Dy, Ho, Er, Tm, Yb, and Lu; A consists of one or more of Sr and Ba; B consists of one or more of Co, Fe, Ni, Cu, Zn, Mn, Cr, and Nd; and δ is an oxygen deficit.

In yet further embodiments, an apparatus comprises at least one structure comprising Pr_{0.5}La_{0.5}BaCo₂O_{5+δ}, wherein δ is an oxygen deficit.

### BRIEF DESCRIPTION OF THE DRAWINGS

FIG. 1 is a simplified schematic view of an electrochemical cell for H₂ gas production and electricity generation, in accordance with an embodiment of the disclosure.

FIG. 2 is a simplified perspective view of the lattice structure of a triple conducting layered perovskite of an electrode of the electrochemical cell shown in FIG. 1.

FIG. 3 is a simplified schematic view of a system for H₂ gas production and electricity generation including the electrochemical cell shown in FIG. 1, in accordance with an embodiment of the disclosure.

FIG. 4 is a graphical representation of current-voltage curves measured at different temperatures within the range of from 500° C. to 600° C. during operation of an electrochemical cell of the disclosure in electrolysis mode, as described in Example 1.

FIG. 5 is a graphical representation of a current-voltage curve of an electrochemical cell configuration of the disclosure at 600° C. as compared to current-voltage curves of some other electrochemical cell configurations at 600° C., as described in Example 2.

### DETAILED DESCRIPTION

The following description provides specific details, such as material compositions and processing conditions (e.g., temperatures, pressures, flow rates, etc.) in order to provide a thorough description of embodiments of the disclosure. However, a person of ordinary skill in the art will understand that the embodiments of the disclosure may be practiced without necessarily employing these specific details. Indeed, the embodiments of the disclosure may be practiced in conjunction with conventional systems and methods employed in the industry. In addition, only those process components and acts necessary to understand the embodiments of the present disclosure are described in detail below. A person of ordinary skill in the art will understand that some process components (e.g., pipelines, line filters, valves, temperature detectors, flow detectors, pressure detectors, and the like) are inherently disclosed herein and that adding various conventional process components and acts would be in accord with the disclosure. In addition, the drawings accompanying the application are for illustrative purposes only, and are not meant to be actual views of any particular material, device, or system.

As used herein, the term “negative electrode” means and includes an electrode having a relatively lower electrode potential in an electrochemical cell (i.e., lower than the electrode potential in a positive electrode therein). Conversely, as used herein, the term “positive electrode” means and includes an electrode having a relatively higher electrode potential in an electrochemical cell (i.e., higher than the electrode potential in a negative electrode therein).

As used herein, the term “electrolyte” means and includes an ionic conductor, which can be in a solid state, a liquid state, or a gas state (e.g., plasma).

As used herein, the term “compatible” means that a material does not undesirably react, decompose, or absorb another material, and also that the material does not undesirably impair the chemical and/or mechanical properties of the another material.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures. For example, if materials in the figures are inverted, elements described as “below” or “beneath” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, “and/or” includes any and all combinations of one or more of the associated listed items.

As used herein, the term “configured” refers to a size, shape, material composition, material distribution, orientation, and arrangement of one or more of at least one structure and at least one apparatus facilitating operation of one or more of the structure and the apparatus in a pre-determined way.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, at least 99.9% met, or even 100.0% met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

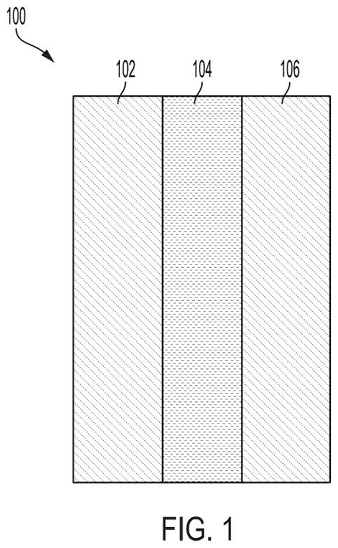

An embodiment of the disclosure will now be described with reference to FIG. 1, which schematically illustrates an electrochemical cell 100. As shown in FIG. 1, the electrochemical cell 100 includes a first electrode 102 (e.g., a steam side electrode), a second electrode 106 (e.g., an H₂ gas side electrode), and a proton-conducting membrane 104 between the first electrode 102 and the second electrode 106. As described in further detail below, the electrochemical cell 100 may be operated in an electrolysis mode to produce H₂ gas from steam (e.g., gaseous H₂O), and may also be operated (e.g., reversibly operated) in a fuel cell mode to generate electricity from H₂ gas (e.g., at least a portion of the H₂ gas produced when the electrochemical cell 100 is operated in the electrolysis mode).

The first electrode 102 (e.g., steam side electrode) may be formed of and include a triple conducting layered perovskite compatible with the material compositions of the proton-conducting membrane 104 and the second electrode 106 and the operating conditions (e.g., temperature, pressure, current density, etc.) of the electrochemical cell 100. As used herein the term “triple conducting layered perovskite” means and includes a layered perovskite formulated to conduct hydrogen ions (H⁺) (i.e., protons), oxygen ions (O²⁻), and electrons (e⁻). The triple conducting layered perovskite of the first electrode 102 may facilitate the production of H₂ gas from steam (e.g., through water splitting reaction (WSR)) when the electrochemical cell 100 is operated in electrolysis mode at a temperature within the range of from about 400° C. to about 700° C., and may also facilitate electricity generation from H₂ gas (e.g., the oxygen reduction reaction (ORR)) when the electrochemical cell 100 is operated in fuel cell mode at a temperature within the range of from about 400° C. to about 700° C. (e.g., from about 400° C. to about 600° C.).

The triple conducting layered perovskite of the first electrode 102 may exhibit a lattice structure having the general formula:

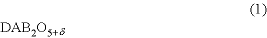

wherein two or more lanthanide elements (e.g., lanthanum (La), cerium (Ce), praseodymium (Pr), neodymium (Nd), promethium (Pm), samarium (Sm), europium (Er), gadolinium (Gd), terbium (Tb), dysprosium (Dy), holmium (Ho), erbium (Er), thulium (Tm), ytterbium (Yb), lutetium (Lu)) occupy “D” sites in the lattice structure; one or more of strontium (Sr) and barium (Ba) occupy “A” sites in the lattice structure; and one or more of cobalt (Co), iron (Fe), nickel (Ni), copper (Cu), zinc (Zn), manganese (Mn), chromium (Cr), and neodymium (Nd) occupy “B” sites in the lattice structure; and δ is the oxygen deficiency. By way of non-limiting example, the triple conducting layered perovskite of the first electrode 102 may comprise (Pr₁₋ₓLnₓ)(Ba_{y},Sr_{1-y})(Co_{z},Tn_{1-z})O_{5+δ}, wherein Ln is selected from La, Nd, Ce, Pm, Sm, Er, Gd, Dy, Ho, and Yb; Tn is selected from Fe, Ni, Cu, Zn, Mn, Cr, and Nd; 0≤x≤1; 0≤y≤1; and 0≤z≤1. In some embodiments, the triple conducting perovskite of the first electrode 102 comprises Pr_{0.5}La_{0.5}BaCo₂O_{5+δ} (hereinafter also referred to as “PLBC”).

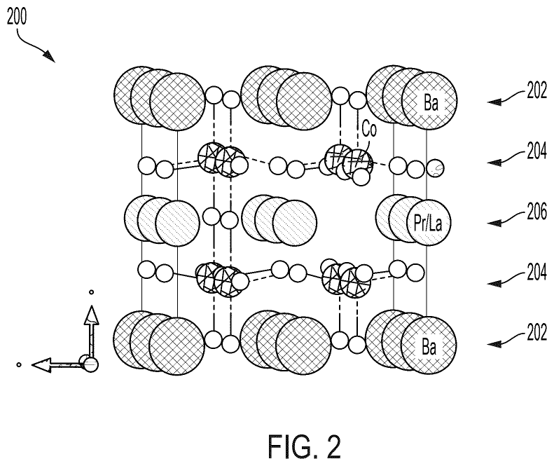

FIG. 2 shows a simplified perspective view of the lattice structure 200 of PLBC. The lattice structure 200 of PLBC may include one or more (e.g., two or more) barium oxide (BaO) layers 202, one or more (e.g., two or more) cobalt oxide (CoO₂) layers 204, and one or more praseodymium/lanthanum oxide (Pr_{0.5}La_{0.5}O_{z}, wherein z<1) layers 206. For example, as shown in FIG. 2, the lattice structure 200 of PLBC may include at least two (2) BaO layers 202, at least two (2) CoO₂ layers 204 intervening between the at least two (2) BaO layers 202, and at least one (1) Pr_{0.5}La_{0.5}O_{z} layer 206 intervening between the at least two (2) CoO₂ layers 204. Put another way, the lattice structure 200 of PLBC may exhibit a stack sequence including a first BaO layer 202, a first CoO₂ layer 204 on or over the first BaO layer 202, a first Pr_{0.5}La_{0.5}O_{z} layer 206 on or over the first CoO₂ layer 204, a second CoO₂ layer 204 on or over the first Pr_{0.5}La_{0.5}O_{z} layer 206, and a second BaO layer 202 on or over the second CoO₂ layer 204. The stacking sequence may continue (e.g., a third CoO₂ layer 204 may be positioned on or over the second BaO layer 202, a second Pr_{0.5}La_{0.5}O_{z} layer 206 may be positioned on or over the third CoO₂ layer 204, a fourth CoO₂ layer 204 may be positioned on or over the second Pr_{0.5}La_{0.5}O_{z} layer 206, and a third BaO layer 202 may be positioned on or over the fourth CoO₂ layer 204, and so on) up to a desired thickness of the triple conducting layered perovskite of the first electrode 102 (FIG. 1).

With returned reference to FIG. 1, the proton-conducting membrane 104 of the electrochemical cell 100 may be formed of and include at least one electrolyte material compatible with the material compositions of the first electrode 102 and the second electrode 106 under the operating conditions (e.g., temperature, pressure, current density, etc.) of the electrochemical cell 100. The electrolyte material of the proton-conducting membrane 104 may be formulated to remain substantially adhered (e.g., laminated) to the first electrode 102 and the second electrode 106 at relatively high current densities, such as at current densities greater than or equal to about 0.1 amperes per square centimeter (A/cm²) (e.g., greater than or equal to about 0.5 A/cm², greater than or equal to about 1.0 A/cm², greater than or equal to about 2.0 A/cm², greater than or equal to about 3.0 A/cm², greater than or equal to about 4.0 A/cm², etc.). In some embodiments, the electrolyte material of the proton-conducting membrane 104 comprises a perovskite having an ionic conductivity (e.g., H⁺ conductivity) greater than or equal to about 10⁻² S/cm (e.g., within a range of from about 10⁻² S/cm to about 1 S/cm) at one or more temperatures within a range of from about 400° C. to about 700° C.

By way of non-limiting example, the proton-conducting membrane 104 may comprise one or more a yttrium- and ytterbium-doped barium-cerate-zirconate (BCZYYb), such as BaCeyZr_{0.8-y}Y_{0.2-x}YbₓO_{3-δ}, wherein x and y are dopant levels and δ is the oxygen deficit (e.g., BaCe_{0.4}Zr_{0.4}Y_{0.1}Yb_{0.1}O_{3-δ}; BaCe_{0.5}Zr_{0.3}Y_{0.1}Yb_{0.1}O_{3-δ}; BaCe_{0.7}Zr_{0.1}Y_{0.1}Yb_{0.1}O_{3-δ}; etc.); a yttrium- and ytterbium-doped barium-strontium-niobate (BSNYYb), such as Ba₃(Sr₁₋ₓNb_{2-y}YₓYb_{y})O_{9-δ}, wherein x and y are dopant levels and δ is the oxygen deficit; doped barium-cerate (BaCeO₃) (e.g., yttrium-doped BaCeO₃ (BCY)); doped barium-zirconate (BaZrO₃) (e.g., yttrium-doped BaCeO₃ (BZY)); barium-yttrium-stannate (Ba₂(YSn)O_{5.5}); and barium-calcium-niobate (Ba₃(CaNb₂)O₉). In some embodiments, the proton-conducting membrane 104 comprises a BCZYYb.

The second electrode 106 (e.g., H₂ gas side electrode) of the electrochemical cell 100 may be formed of and include material compatible with the material compositions of the first electrode 102 and the proton-conducting membrane 104 under the operating conditions (e.g., temperature, pressure, current density, etc.) of the electrochemical cell 100. The material composition of the second electrode 106 may permit the production of H₂ gas from steam when the electrochemical cell 100 is operated in electrolysis mode at an operational temperature within the range of from about 400° C. to about 700° C. (e.g., from about 400° C. to about 600° C.), and may also permit electricity generation from H₂ gas when the electrochemical cell 100 is operated in fuel cell mode at an operational temperature within the range of from about 400° C. to about 700° C. (e.g., from about 400° C. to about 600° C.).

By way of non-limiting example, the second electrode 106 may comprise a cermet material including at least one metal (e.g., Ni) and at least one perovskite, such as a nickel/perovskite cermet (Ni-perovskite) material (e.g., a Ni—BCZYYb, such as Ni—BaCe_{0.4}Zr_{0.4}Y_{0.1}Yb_{0.1}O_{3-δ}, Ni—BaCe_{0.5}Zr_{0.3}Y_{0.1}Yb_{0.1}O_{3-δ}, or Ni—BaCe_{0.7}Zr_{0.1}Y_{0.1}Yb_{0.1}O_{3-δ}; a Ni—BSNYYb; Ni—BaCeO₃; Ni—BaZrO₃; Ni—Ba₂(YSn)O_{5.5}; Ni—Ba₃(CaNb₂)O₉). In some embodiments, the second electrode 106 comprises a Ni—BCZYYb.

The first electrode 102, the second electrode 106, and the proton-conducting membrane 104 may each individually exhibit any desired dimensions (e.g., length, width, thickness) and any desired shape (e.g., a cubic shape, cuboidal shape, a tubular shape, a tubular spiral shape, a spherical shape, a semi-spherical shape, a cylindrical shape, a semi-cylindrical shape, a conical shape, a triangular prismatic shape, a truncated version of one or more of the foregoing, and irregular shape). The dimensions and the shapes of the first electrode 102, the second electrode 106, and the proton-conducting membrane 104 may be selected relative to one another such that the proton-conducting membrane 104 substantially intervenes between opposing surfaces of the first electrode 102 and the second electrode 106. In some embodiments, the first electrode 102 and the second electrode 106 each individually exhibit a thickness within a range of from about 10 micrometers (μm) to about 1000 μm; and the proton-conducting membrane 104 exhibit a thickness within a range of from about 5 μm to about 1000 μm.

The electrochemical cell 100, including the first electrode 102, the proton-conducting membrane 104, and the second electrode 106 thereof, may be formed using conventional processes (e.g., rolling process, milling processes, shaping processes, pressing processes, consolidation processes, etc.), which are not described in detail herein. The electrochemical cell 100 may be mono-faced or bi-faced, and may have a prismatic, folded, wound, cylindrical, or jelly rolled configuration.

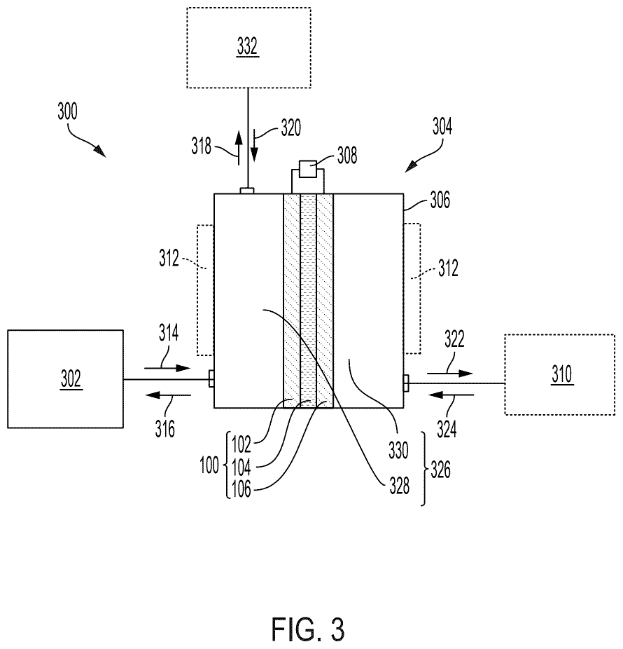

Electrochemical cells (e.g., the electrochemical cell 100) in accordance with embodiments of the disclosure may be used in embodiments of H₂ gas production and electricity generation systems of the disclosure. For example, FIG. 3 schematically illustrates a system 300 for producing H₂ gas and generating electricity, according to embodiments of disclosure. As shown in FIG. 1, the system 300 includes at least one steam source 302, and at least one electrochemical apparatus 304 in fluid communication with the steam source 302. The electrochemical apparatus 304 includes a housing structure 306, and one or more embodiments of the electrochemical cell 100 previously described with reference to FIG. 1 contained within the housing structure 306. The electrochemical cell 100 is electrically connected (e.g., coupled) to a power source 308, and includes the first electrode 102 (e.g., steam side electrode), the second electrode 106 (e.g., H₂ gas side electrode), and the proton-conducting membrane 104 between the first electrode 102 and the second electrode 106. As shown in FIG. 3, optionally, the system 300 may also include one or more of at least one H₂ gas source 310 in fluid communication with the electrochemical apparatus 304, at least one O₂ gas source 332 in fluid communication with the electrochemical apparatus 304, and at least one heating apparatus 312 operatively associated with the electrochemical apparatus 304.

The steam source 302 comprises at least one apparatus configured and operated to produce a steam stream 314 including steam (e.g., gaseous H₂O). The steam stream 314 may be directed into the electrochemical apparatus 304 from the steam source 302 to interact with the first electrode 102 of the electrochemical cell 100 therein when the electrochemical cell 100 is operated in electrolysis mode, as described in further detail below. The steam source 302 may also receive an H₂O stream 316 containing one or more phases of H₂O (e.g., steam) exiting the electrochemical apparatus 304 when the electrochemical cell 100 is operated in fuel cell mode, as also described in detail herein. By way of non-limiting example, the steam source 302 may comprise a boiler apparatus configured and operated to heat liquid H₂O to a temperature greater than or equal to 100° C. In some embodiments, the steam source 302 is configured and operated to convert the liquid H₂O to steam having a temperature within a range of an operating temperature of the electrochemical cell 100 of the electrochemical apparatus 304, such as a temperature within a range of from about 400° C. to about 700° C. (e.g., from about 400° C. to about 600° C.). In some embodiments, the steam source 302 is configured and operated to convert the liquid H₂O into steam having a temperature below the operating temperature of the electrochemical cell 100. In such embodiments, the heating apparatus 312 may be employed to further heat the steam stream 314 to the operational temperature of the electrochemical cell 100, as described in further detail below.

The electrochemical apparatus 304, including the housing structure 306 and the electrochemical cell 100 thereof, is configured and operated to facilitate the production of H₂ gas from steam (e.g., steam of the steam stream 314) when the electrochemical cell 100 is operated in electrolysis mode, and to facilitate the electricity generation from H₂ gas (e.g., the H₂ gas produced when the electrochemical cell 100 is operated in electrolysis mode) when the electrochemical cell 100 is operated in fuel cell mode. The housing structure 306 may exhibit any shape (e.g., a tubular shape, a quadrilateral shape, a spherical shape, a semi-spherical shape, a cylindrical shape, a semi-cylindrical shape, truncated versions thereof, or an irregular shape) and size able to contain (e.g., hold) the electrochemical cell 100 therein. In addition, the housing structure 306 is configured, such that when the electrochemical cell 100 is operated in electrolysis mode, the housing structure 306 may receive and directs the steam stream 314 to the first electrode 102 of the electrochemical cell 100, may direct O₂ gas produced at the first electrode 102 of the electrochemical cell 100 away from the electrochemical apparatus 304 as an O₂ gas stream 318, and may optionally direct H₂ gas produced at the second electrode 106 of the electrochemical cell 100 away from the electrochemical apparatus 304 as an H₂ gas stream 322. The housing structure 306 may also be configured, such that when the electrochemical cell 100 is operated in fuel cell mode, the housing structure 306 may receive and direct a H₂ gas-containing stream 324 to the second electrode 106 of the electrochemical cell 100, may receive and direct a O₂ gas-containing stream 320 to the first electrode 102 of the electrochemical cell 100, and may direct H₂O produced at the first electrode 102 of the electrochemical cell 100 away from the electrochemical apparatus 304 as an H₂O stream 316. The housing structure 306 may be formed of and include any material (e.g., glass, metal, alloy, polymer, ceramic, composite, combination thereof, etc.) compatible with the operating conditions (e.g., temperatures, pressures, etc.) of the electrochemical apparatus 304.

The housing structure 306 of the electrochemical apparatus 304 may at least partially define at least one internal chamber 326 at least partially surrounding the electrochemical cell 100. The electrochemical cell 100 may serve as a boundary between a first region 328 (e.g., a steam region) of the internal chamber 326 configured and positioned to temporarily contain steam, and a second region 330 (e.g., an H₂ gas region) of the internal chamber 326 configured and positioned to temporarily contain H₂ gas. H₂O (e.g., steam) may be substantially limited to the first region 328 of the internal chamber 326 by the configurations and positions of the housing structure 306 and the electrochemical cell 100. Keeping the second region 330 of the internal chamber 326 substantially free of the H₂O circumvents additional processing of produced H₂ gas (e.g., to separate the produced H₂ gas from steam) that may otherwise be necessary if the H₂O (e.g., steam) was provided within the second region 330 of the internal chamber 326. In addition, protecting the second electrode 106 of the electrochemical cell 100 from exposure to H₂O may enhance the operational life (e.g., durability) of the electrochemical cell 100 as compared to conventional electrochemical cells by preventing undesirable oxidation of the second electrode 106 that may otherwise occur in the presence of H₂O.

Although the electrochemical apparatus 304 is depicted as including a single (i.e., only one) electrochemical cell 100 in FIG. 3, the electrochemical apparatus 304 may include any number of electrochemical cells 100. Put another way, the electrochemical apparatus 304 may include a single (e.g., only one) electrochemical cell 100, or may include multiple (e.g., more than one) electrochemical cells 100. If the electrochemical apparatus 304 includes multiple electrochemical cells 100, each of the electrochemical cells 100 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical cells 100 may be different (e.g., exhibit one or more of different components, different component sizes, different component shapes, different component material compositions, different component material distributions, different component positions, different component orientations, etc.) than at least one other of the electrochemical cells 100 and/or may be operated under different conditions (e.g., different temperatures, different pressures, different flow rates, etc.) than at least one other of the electrochemical cells 100. By way of non-limiting example, one of the electrochemical cells 100 may be configured for and operated under a different temperature (e.g., different operating temperature resulting from a different material composition of one of more components thereof) than at least one other of the electrochemical cells 100. In some embodiments, two of more electrochemical cells 100 are provided in parallel with one another within the housing structure 306 of the electrochemical apparatus 304.

Although the system 300 is depicted as including a single (i.e., only one) electrochemical apparatus 304 in FIG. 3, the system 300 may include any number of electrochemical apparatuses 304. Put another way, the system 300 may include a single (e.g., only one) electrochemical apparatus 304, or may include multiple (e.g., more than one) electrochemical apparatuses 304. If the system 300 includes multiple electrochemical apparatuses 304, each of the electrochemical apparatuses 304 may be substantially the same (e.g., exhibit substantially the same components, component sizes, component shapes, component material compositions, component material distributions, component positions, component orientations, etc.) and may be operated under substantially the same conditions (e.g., substantially the same temperatures, pressures, flow rates, etc.), or at least one of the electrochemical apparatus 304 may be different (e.g., exhibit one or more of different components, different component sizes, different component shapes, different component material compositions, different component material distributions, different component positions, different component orientations, etc.) than at least one other of the electrochemical apparatuses 304 and/or may be operated under different conditions (e.g., different temperatures, different pressures, different flow rates, etc.) than at least one other of the electrochemical apparatuses 304. By way of non-limiting example, one of the electrochemical apparatuses 304 may be configured for and operated under a different temperature (e.g., a different operating temperature resulting from a different material composition of one of more components of one or more electrochemical cell(s) 100 thereof) than at least one other of the electrochemical apparatuses 304. In some embodiments, two of more electrochemical apparatuses 304 are provided in parallel with one another. In some embodiments, two of more electrochemical apparatuses 304 are provided in series with one another.

The power source 308 may comprise one or more of a device, structure, and apparatus able to apply a potential difference (e.g., voltage) between the first electrode 102 of the electrochemical cell 100 and the second electrode 106 of the electrochemical cell 100 to facilitate desired operation (e.g., electrolysis mode operation, fuel cell mode operation) of the electrochemical cell 100. During electrolysis mode operation of the electrochemical cell 100, the potential difference applied between the first electrode 102 and the second electrode 106 permits the first electrode 102 to serve as the positive electrode (e.g., anode) and the second electrode 106 to serve as the negative electrode (e.g., cathode) to facilitate water splitting reaction (WSR) and the production of H₂ gas from steam, as described in further detail below. During fuel cell mode operation of the electrochemical cell 100, the potential difference applied between the first electrode 102 and the second electrode 106 permits the second electrode 106 to serve as the positive electrode (e.g., anode) and the first electrode 102 to serve as the negative electrode (e.g., cathode) to facilitate oxygen reduction reaction (ORR) and the electricity generation using H₂ gas as a fuel, as also described in further detail below. The power source 308 may, for example, comprise one or more of a device, structure, or apparatus configured and operated to exploit one or more of solar energy, wind (e.g., wind turbine) energy, hydropower energy, geothermal energy, nuclear energy, combustion-based energy, and waste heat (e.g., heat generated from one or more of an engine, a chemical process, and a phase change process) to apply a potential difference between the first electrode 102 and the second electrode 106 of the electrochemical cell 100.

The heating apparatus 312, if present, may comprise at least one apparatus (e.g., one or more of a combustion heater, an electrical resistance heater, an inductive heater, and an electromagnetic heater) configured and operated to heat one or more of at least a portion of the electrochemical apparatus 304 and one or more of the streams (e.g., one or more of the steam stream 314, the H₂ gas-containing stream 324, and the O₂ gas-containing stream 320) directed into the electrochemical apparatus 304 during desired operation (e.g., electrolysis mode operation, fuel cell mode operation) of the electrochemical cell 100 to an operating temperature of the electrochemical apparatus 304. The operating temperature of the electrochemical apparatus 304 may at least partially depend on the material compositions of the first electrode 102, the proton-conducting membrane 104, and the second electrode 106 thereof. In some embodiments, the heating apparatus 312 heats one or more of at least a portion of the electrochemical apparatus 304 and one or more of the streams directed into the electrochemical apparatus 304 to a temperature within a range of from about 400° C. to about 700° C. (e.g., from about 400° C. to about 600° C.). In additional embodiments, such as in embodiments wherein a temperature of the streams directed is already within the operating temperature range of the electrochemical cell 100 of the electrochemical apparatus 304, the heating apparatus 312 may be omitted (e.g., absent) from the system 300.

H₂ gas source 310, if present, may comprise one or more of a device, structure, and apparatus configured and operated to produce an H₂ gas-containing stream 324 including H₂ gas. The H₂ gas-containing stream 324 may be directed into the electrochemical apparatus 304 from the H₂ gas source 310 to interact with the second electrode 106 of the electrochemical cell 100 therein when the electrochemical cell 100 is operated in fuel cell mode, as described in further detail below. The H₂ gas source 310 may also receive and temporarily store (e.g., contain) one or more portions of the H₂ gas stream 322 including H₂ gas exiting the electrochemical apparatus 304 when the electrochemical cell 100 is operated in electrolysis mode, as also described in detail herein. The H₂ gas exiting the electrochemical apparatus 304 in the H₂ gas stream 322 during electrolysis mode operation of the electrochemical cell 100 may be employed as at least a portion of the H₂ gas of the H₂ gas-containing stream 324 being directed into the electrochemical apparatus 304 when the electrochemical cell 100 is operated in fuel cell mode. In additional embodiments, such as in embodiments wherein the electrochemical cell 100 is rapidly switched (e.g., in under five (5) minutes, such as in under two (2) minutes, or in under one (1) minute) between electrolysis mode operation and fuel cell mode operation, the H₂ gas source 310 may be omitted. In such embodiments, the at least a portion (e.g., substantially all) of the H₂ gas produced during electrolysis mode operation of the electrochemical cell 100 may be employed as fuel during fuel cell mode operation of the electrochemical cell 100 before the H₂ gas produced H₂ gas can exit the second region 330 of the internal chamber 326 of the housing structure 306.

O₂ gas source 332, if present, may comprise one or more of a device, structure, and apparatus configured and operated to produce an O₂ gas-containing stream 320 including O₂ gas. The O₂ gas-containing stream 320 may be directed into the electrochemical apparatus 304 from the O₂ gas source 332 to interact with the first electrode 102 of the electrochemical cell 100 therein when the electrochemical cell 100 is operated in fuel cell mode, as described in further detail below. The O₂ gas source 332 may also receive and temporarily store (e.g., contain) one or more portions of the O₂ gas stream 318 including O₂ gas exiting the electrochemical apparatus 304 when the electrochemical cell 100 is operated in electrolysis mode, as also described in detail herein. The O₂ gas exiting the electrochemical apparatus 304 in the O₂ gas stream 318 during electrolysis mode operation of the electrochemical cell 100 may be employed as at least a portion of the O₂ gas of the O₂ gas-containing stream 320 being directed into the electrochemical apparatus 304 when the electrochemical cell 100 is operated in fuel cell mode.

When the electrochemical cell 100 of the electrochemical apparatus 304 (and, hence, the electrochemical apparatus 304 itself) is operated in electrolysis mode, the system 300 directs the steam stream 314 from the steam source 302 and into the electrochemical apparatus 304 to interact with the first electrode 102 (e.g., steam side electrode) of the electrochemical cell 100 contained therein. A potential difference (e.g., voltage) is applied between the first electrode 102 (serving as an anode) and the second electrode 106 (serving as a cathode) by the power source 308 so that as steam interacts with the first electrode 102, H atoms of the steam release their electrons (e⁻) to generate oxygen gas (O_{2(g)}), hydrogen ions (H⁺) (i.e., protons), and electrons (e⁻) according to the following equation:

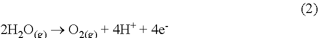

The generated H+ permeate (e.g., diffuse) across the proton-conducting membrane 104 to the second electrode 106, and the generated e⁻ are directed to the power source 308 through external circuitry. The produced O₂ gas may exit the electrochemical apparatus 304 as an O₂ gas stream 318. At the second electrode 106, the generated H⁺ exiting the proton-conducting membrane 104 reacts with e⁻ received from the power source 308 to form H atoms, which then combine to form H₂ gas (H_{2(g)}), according to the following equation:

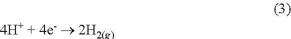

The produced H₂ gas may exit the electrochemical apparatus 304 as the H₂ gas stream 322.

When the electrochemical cell 100 of the electrochemical apparatus 304 (and, hence, the electrochemical apparatus 304 itself) is operated in fuel cell mode, the system 300 employs H₂ gas previously produced by the electrochemical cell 100 when operated in electrolysis mode and/or directed into electrochemical apparatus 304 (e.g., into the second region 330 thereof) from the H₂ gas containment vessel 310 as a H₂ gas-containing stream 324 to interact with the second electrode 106 (e.g., H₂ gas side electrode) of the electrochemical cell 100. A potential difference (e.g., voltage) is applied between the second electrode 106 (serving as an anode) and the first electrode 102 (serving as a cathode) by the power source 308 so that as H₂ gas interacts with the second electrode 106, H atoms of the H₂ gas release their electrons (e⁻) to generate hydrogen ions (H⁺) (i.e., protons) and electrons (e⁻) according to the following equation (the reverse reaction of Equation (2) above):

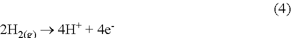

The generated H⁺ permeate (e.g., diffuse) across the proton-conducting membrane 104 to the first electrode 102, and the generated e⁻ are directed to the power source 308 through external circuitry. At the first electrode 102, the generated H⁺ exiting the proton-conducting membrane 104 react with e⁻ received from the power source 308 and O₂ gas previously produced by the electrochemical cell 100 when operated in electrolysis mode and/or directed into electrochemical apparatus 304 (e.g., into the first region 328 thereof) from the O₂ gas source 332 as an O₂ gas-containing stream 320 to generate electricity and produce H₂O, according to the following equation (the reverse reaction of Equation (1) above):

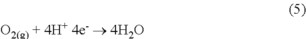

The produced H₂O may exit the electrochemical apparatus 304 as the H₂O stream 316 and may be directed into the steam source 302, and/or may be employed to produce additional H₂ gas when the electrochemical cell 100 of the electrochemical apparatus 304 (and, hence, the electrochemical apparatus 304 itself) is operated in electrolysis mode.

Switching between electrolysis mode operation and fuel cell mode operation of the electrochemical cell 100 may be rapid (e.g., electrolysis and fuel cell operation modes may alternate between one another using relatively short time periods for each operation, such as time periods less than or equal to five (5) minutes, less than or equal to two (2) minutes, or less than or equal to one (1) minute), or may be delayed (e.g., the electrolysis and fuel cell operation modes may not alternate between one another using relatively short time periods). In some embodiments, such as embodiments wherein the electrochemical cell 100 is rapidly switched (e.g., cyclically alternated) between electrolysis mode operation and fuel cell mode operation, at least a portion (e.g., substantially all) of the H₂ gas produced during electrolysis mode operation of the electrochemical cell 100 is consumed as fuel during fuel cell mode operation of the electrochemical cell 100 before the produced H₂ gas can exit the electrochemical apparatus 304 as the H₂ gas stream 322. In additional embodiments, such as embodiments wherein the electrochemical cell 100 is not rapidly switched between electrolysis mode operation and fuel cell mode operation, at least a portion (e.g., substantially all) of the H₂ gas produced during electrolysis mode operation of the electrochemical cell 100 may exit the electrochemical apparatus 304 as the H₂ gas stream 322 and may be stored (e.g., at the H₂ gas source 310, if any) for subsequent use (e.g., for subsequent use as fuel during relatively delayed fuel cell mode operation of the electrochemical cell 100), as desired.

Still referring to FIG. 3, streams exiting the electrochemical apparatus 304 during the different modes of operation (e.g., electrolysis mode operation, fuel cell mode operation) of the electrochemical cell 100 thereof may individually be utilized or disposed of as desired. In some embodiments, one or more of the H₂ gas stream 322 and the O₂ gas stream 318 produced during electrolysis mode operation of the electrochemical cell 100 of the electrochemical apparatus 304 are respectively delivered into one or more storage vessels of the H₂ gas source 310 and the O₂ gas source 332 for subsequent use (e.g., to respectively form the H₂ gas-containing stream 324 and the O₂ gas-containing stream 320 employed during fuel cell mode operation of the electrochemical cell 100), as desired. In additional embodiments, the H₂O stream 316 produced during fuel cell mode operation of the electrochemical cell 100 of the electrochemical apparatus 304 is delivered into one or more storage vessels of the steam source 302 for subsequent use (e.g., to form the steam stream 314 employed during electrolysis mode operation of the electrochemical cell 100), as desired. In further embodiments, at least a portion of one or more of the streams (e.g., the H₂ gas stream 322 and the O₂ gas stream 318) may be utilized (e.g., combusted) to heat one or more components (e.g., the heating apparatus 312 (if present); the electrochemical apparatus 304; etc.) and/or other streams (e.g., the steam stream 314) of the system 300. By way of non-limiting example, if the heating apparatus 312 (if present) is a combustion-based apparatus, at least a portion of one or more of the H₂ gas stream 322 and the O₂ gas stream 318 may be directed into the heating apparatus 312 and undergo an combustion reaction to efficiently heat the steam stream 314 entering the electrochemical apparatus 304 and/or at least a portion of the electrochemical apparatus 304 during electrolysis mode operation of the electrochemical cell 100. Utilizing the H₂ gas stream 322 and/or the O₂ gas stream 318 as described above may reduce the electrical power requirements of the system 300 by enabling the utilization of direct thermal energy.

Thermal energy input into (e.g., through the heating apparatus 312 (if present)) and/or generated by the electrochemical apparatus 304 may also be used to heat one or more other components and/or streams of the system 300. As a non-limiting example, during electrolysis mode operation of the electrochemical cell 100 of the electrochemical apparatus 304, one or more of the H₂ gas stream 322 and the O₂ gas stream 318 exiting the electrochemical apparatus 304 may be directed into a heat exchanger configured and operated to facilitate heat exchange between the H₂ gas stream 322 and/or the O₂ gas stream 318 of the system 300 and one or more other relatively cooler streams (e.g., in some embodiments, the steam stream 314) of the system 300 to transfer heat from the H₂ gas stream 322 and/or the O₂ gas stream 318 to the relatively cooler stream(s) to facilitate the recovery of the thermal energy input into and generated within the electrochemical apparatus 304. The recovered thermal energy may increase process efficiency and/or reduce operational costs without having to react (e.g., combust) the H₂ gas stream 322 and/or the O₂ gas stream 318. As another non-limiting example, during fuel cell mode operation of the electrochemical cell 100 of the electrochemical apparatus 304, the H₂O stream 316 exiting the electrochemical apparatus 304 may be directed into a heat exchanger configured and operated to facilitate heat exchange between the H₂O stream 316 of the system 300 and one or more other relatively cooler streams (e.g., in some embodiments, one or more of the O₂ gas-containing stream 320 and the H₂ gas-containing stream 324) of the system 300 to transfer heat from H₂O stream 316 to the relatively cooler stream(s) to facilitate the recovery of the thermal energy input into and generated within the electrochemical apparatus 304. The recovered thermal energy may increase process efficiency and/or reduce operational costs without having to react (e.g., combust) one or more of the streams employed in the system 300.

The electrochemical cells (e.g., the electrochemical cell 100), structures (e.g., the first electrode 102), apparatuses (e.g., the electrochemical apparatus 304), systems (e.g., the system 300), and methods of the disclosure facilitate the simple and efficient H₂ gas production and electricity generation at intermediate temperatures, such as temperatures within a range of from about 400° to about 700° C. (e.g., from about 400° to about 600° C.). The electrochemical cells, structures, apparatuses, systems, and methods of the disclosure may reduce one or more of the time (e.g., processing steps), costs (e.g., material costs), and energy (e.g., thermal energy, electrical energy, etc.) required to produce H₂ gas and/or generate electricity relative to conventional electrochemical cells, structures, apparatuses, systems, and methods. The electrochemical cells, structures, apparatuses, systems, and methods of the disclosure may be more efficient, durable, and reliable that conventional electrochemical cells, conventional structures, conventional apparatuses, conventional systems, and conventional methods of H₂ gas production and electricity generation.

The following examples serve to explain embodiments of the disclosure in more detail. These examples are not to be construed as being exhaustive, exclusive, or otherwise limiting as to the scope of the disclosure.

### EXAMPLES

### Example 1: Electrolysis Mode Performance of an Electrochemical Cell

An electrochemical cell exhibiting the general configuration of the electrochemical cell 100 shown in FIG. 1 was subjected to electrolysis mode performance analysis. The electrochemical cell included a first electrode (steam side electrode) comprising PLBC, a proton conducting membrane comprising BaCe_{0.7}Zr_{0.1}Y_{0.1}Yb_{0.1}O₃, and a second electrode (H₂ gas side electrode) comprising Ni—BaCe_{0.7}Zr_{0.1}Y_{0.1}Yb_{0.1}O₃. The electrochemical cell was operated in electrolysis mode at different temperatures within a range of from about 500° C. to about 600° C. Humid air (3% H₂O, 80 mL/min) and 10% H₂ gas were respectively fed to the first electrode and the second electrode of the electrochemical cell.

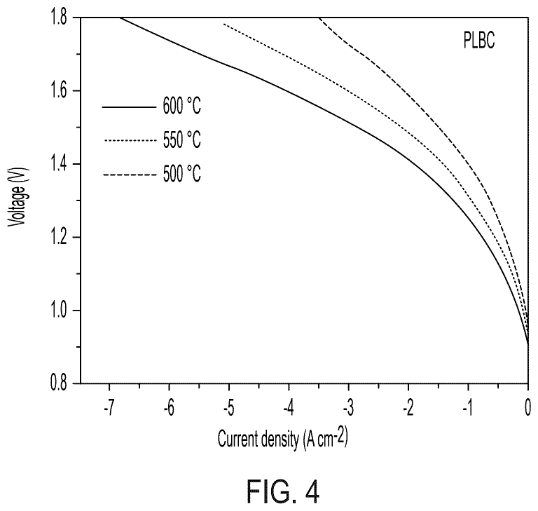

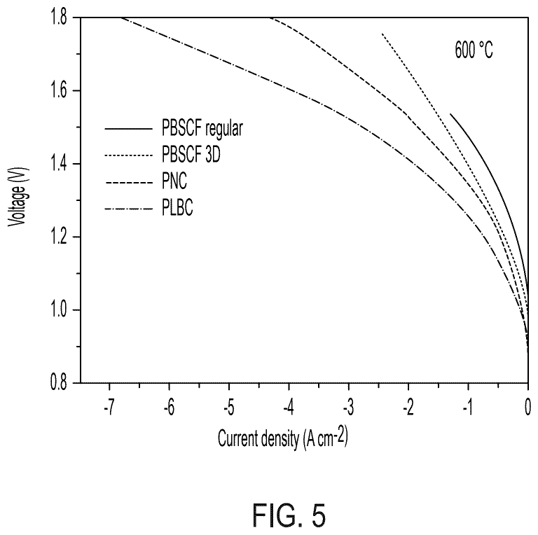

FIG. 4 is a graphical representation of the results of the analysis for the electrochemical cell. As shown in FIG. 5, the electrochemical cell achieved high electrolysis current densities at 1.4V and 1.6V at each of 500°° C., 550° C., and 600° C. For example, at 1.4V and 600°° C., the electrolysis current density reached 2.0 A/cm², and at 1.6V and 600° C., the electrolysis current density reached 4.1 A/cm². The results of the electrolysis mode performance analysis demonstrate that PLBC is very active towards water splitting reaction (WSR) at low temperatures.

### Example 2: Comparison of Electrolysis Mode Performance

The electrolysis mode performance of an electrochemical cell exhibiting the general configuration of the electrochemical cell 100 shown in FIG. 1, including a first electrode (steam side electrode) comprising PLBC, a proton conducting membrane comprising BaCe_{0.7}Zr_{0.1}Y_{0.1}Yb_{0.1}O₃, and a second electrode (H₂ gas side electrode) comprising Ni—BaCe_{0.7}Zr_{0.1}Y_{0.1}Yb_{0.1}O₃ was compared against that of other electrochemical cells including different material compositions of first electrode, and the same material compositions of the proton conducting membrane and second electrode. One of the other electrochemical cells included a first electrode comprising PrBa_{0.5}Sr_{0.5}Co_{1.5}Fe_{0.5}O_{5+δ} (PBSCF), another of the other electrochemical cells included a first electrode comprising 3D-PBSCF, and yet another of the other electrochemical cells included a first electrode comprising PrNi_{0.5}Co_{0.5}O_{3-δ} (PNC).

FIG. 5 is a graphical representation of the results of the analysis. The results indicate that the electrochemical cell configuration of the disclosure exhibits improved performance (e.g., higher current density) at relatively lower operational temperatures (e.g., 600° C.) as compared to other electrochemical cell configurations.

While the disclosure is susceptible to various modifications and alternative forms, specific embodiments have been shown by way of example in the drawings and have been described in detail herein. However, the disclosure is not limited to the particular forms disclosed. Rather, the disclosure is to cover all modifications, equivalents, and alternatives falling within the scope of the accompanying claims and their legal equivalent. For example, elements and features disclosed in relation to one embodiment may be combined with elements and features disclosed in relation to other embodiments of the disclosure.

1. A method of generating electricity, comprising:
introducing steam to an electrochemical cell comprising:
a first electrode comprising (Pr₁₋ₓLnₓ)(Ba_{y},Sr_{1-y})(Co_{z},Tn_{1-z})O_{5+δ}, wherein Ln is selected from La, Nd, Ce, Pm, Sm, Er, Gd, Dy, Ho, and Yb; Tn is selected from Fe, Ni, Cu, Zn, Mn, Cr, and Nd; 0≤x≤1; 0≤y≤1; 0≤z≤1; and δ is an oxygen deficit;
a second electrode comprising a metal/perovskite cermet; and
a proton-conducting membrane between the first electrode and the second electrode;
applying a potential difference between the first electrode and the second electrode of the electrochemical cell to operate the electrochemical cell in an electrolysis mode to produce H₂ gas from the steam; and
subsequently, at a different time, introducing at least a portion of the produced H2 gas to the electrochemical cell to reversibly operate the electrochemical cell in a fuel cell mode to generate electricity using the produced H₂ gas as a fuel.

2. The method of claim 1, wherein applying the potential difference between the first electrode and the second electrode to operate the electrochemical cell in the electrolysis mode comprises decomposing the steam at the first electrode and produce the H₂ gas at the second electrode.

3. The method of claim 1, wherein introducing the at least a portion of the produced H2 gas to the electrochemical cell to reversibly operate the electrochemical cell in the fuel cell mode comprises decomposing the at least a portion of the produced H₂ gas at the second electrode and produce H₂O at the first electrode.

4. The method of claim 1, wherein:
applying the potential difference between the first electrode and the second electrode comprises applying the first potential difference at a temperature within a range of from about 400° C. to about 700° C.

5. A method of generating electricity, comprising:
introducing steam to an electrochemical cell comprising:
a first electrode configured to produce oxygen gas (O₂) from the steam and comprising a layered perovskite having a general formula: 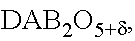
wherein:
D consists of two or more lanthanide (Ln) elements;
A consists of one or more of Sr and Ba;
B consists of one or more of Co, Fe, Ni, Cu, Zn, Mn, Cr, and Nd; and
δ is an oxygen deficit;
a second electrode configured to produce H₂ gas from the steam; and
a proton-conducting membrane between the first electrode and the second electrode;
applying a potential difference between the first electrode and the second electrode of the electrochemical cell to operate the electrochemical cell in an electrolysis mode to produce H₂ gas and oxygen gas from the steam; and
subsequently introducing at least a portion of the produced H₂ gas to the electrochemical cell to operate the electrochemical cell in a fuel cell mode to generate electricity using the produced H₂ gas as a fuel.

6. The method of claim 5, wherein:
applying the potential difference between the first electrode and the second electrode of the electrochemical cell to produce H₂ gas and oxygen gas from the steam comprises delivering the produced H₂ gas from the electrochemical cell to a storage vessel; and
introducing the at least a portion of the produced H₂ gas to the electrochemical cell to generate electricity comprises delivering the at least a portion of the produced H₂ gas from the storage vessel to the electrochemical cell.

7. The method of claim 5, further comprising directing at least a portion of the produced O₂ gas from the electrochemical cell into a heat exchanger.

8. The method of claim 5, wherein introducing the steam to the electrochemical cell to operate the electrochemical cell in the fuel cell mode comprises introducing the steam to the electrochemical cell including the first electrode comprising Pr_{0.5}La_{0.5}BaCo₂O_{5+δ}.

9. The method of claim 5, wherein introducing the steam to the electrochemical cell to operate the electrochemical cell in the fuel cell mode comprises introducing the steam to the electrochemical cell including the second electrode comprising a nickel/perovskite cermet.

10. The method of claim 5, wherein introducing the steam to the electrochemical cell to operate the electrochemical cell in the fuel cell mode comprises introducing the steam to the electrochemical cell including a proton-conducting membrane comprising a perovskite having an ionic conductivity greater than or equal to about 10⁻² S/cm at one or more temperatures within a range of from about 400° C. to about 700° C.

11. The method of claim 5, wherein introducing the steam to the electrochemical cell to operate the electrochemical cell in the fuel cell mode comprises introducing the steam to the electrochemical cell including a proton-conducting membrane comprising a yttrium- and ytterbium-doped barium-cerate-zirconate (BCZYYb), a yttrium- and ytterbium-doped barium-strontium-niobate (BSNYYb), a doped barium-cerate (BaCeO₃), a doped barium-zirconate (BaZrO₃), a barium-yttrium-stannate (Ba₂(YSn)O_{5.5}), a barium-calcium-niobate (Ba₃(CaNb₂)O₉), or a combination thereof.

12. A method of generating electricity, comprising:
providing an electrochemical cell configured to be reversibly operable in an electrolysis mode and a fuel cell mode;
introducing hydrogen gas to the electrochemical cell when operating in the fuel cell mode to generate the electricity, the electrochemical cell including:
a hydrogen gas side electrode configured to oxidize the hydrogen gas to produce protons;
a steam side electrode configured to reduce oxygen gas to produce H₂O, the steam side electrode comprising a layered perovskite having a general formula: 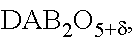
wherein:
D consists of two or more of La, Ce, Pr, Nd, Pm, Sm, Er, Gd, Tb, Dy, Ho, Er, Tm, Yb, and Lu;
A consists of one or more of Sr and Ba;
B consists of one or more of Co, Fe, Ni, Cu, Zn, Mn, Cr, and Nd; and
δ is an oxygen deficit; and
a proton-conducting membrane between the hydrogen gas side electrode and the steam side electrode.

13. The method of claim 12, further comprising applying a potential difference between the hydrogen gas side electrode and the steam side electrode of the electrochemical cell when operating in the electrolysis mode.

14. The method of claim 12, wherein introducing the hydrogen gas to the electrochemical cell comprises introducing the hydrogen gas to the electrochemical cell including the hydrogen gas side electrode comprising a metal/perovskite cermet.

15. The method of claim 12, wherein introducing the hydrogen gas to the electrochemical cell comprises introducing the hydrogen gas to the electrochemical cell including the hydrogen gas side electrode comprising the nickel metal and the yttrium- and ytterbium-doped barium-cerate-zirconate, a nickel metal and a yttrium- and ytterbium-doped barium-strontium-niobate, or a mixture thereof.

16. The method of claim 12, wherein introducing the hydrogen gas to the electrochemical cell comprises introducing the hydrogen gas to the electrochemical cell including the hydrogen gas side electrode comprising a Ni—BaCe_{0.4}Zr_{0.4}Y_{0.1}Yb_{0.1}O_{3-δ}, a Ni—BaCe_{0.5}Zr_{0.3}Y_{0.1}Yb_{0.1}O_{3-δ}, a Ni—BaCe_{0.7}Zr_{0.1}Y_{0.1}Yb_{0.1}O_{3-δ}, or a combination thereof.

17. The method of claim 12, wherein introducing the hydrogen gas to the electrochemical cell comprises:
introducing the hydrogen gas to the electrochemical cell including the proton-conducting membrane formulated to remain substantially adhered to the hydrogen gas side electrode and the steam side electrode when a current density of greater than or equal to about 0.1 amperes per square centimeter (A/cm²) is applied to the electrochemical cell.

18. The method of claim 12, wherein introducing the hydrogen gas to the electrochemical cell comprises:
introducing the hydrogen gas to the electrochemical cell including the proton-conducting membrane comprising a yttrium- and ytterbium-doped barium-cerate-zirconate of formula Ce_{y}Zr_{0.8-y}Y_{0.2-x}YbₓO_{3-δ}, wherein x and y are dopant levels and δ is an oxygen deficit.

19. The method of claim 12, wherein introducing the hydrogen gas to the electrochemical cell comprises:
introducing the hydrogen gas to the electrochemical cell including the proton-conducting membrane comprising BaCe_{0.4}Zr_{0.4}Y_{0.1}Yb_{0.1}O_{3-δ}, BaCe_{0.5}Zr_{0.3}Y_{0.1}Yb_{0.1}O_{3-δ}, BaCe_{0.7}Zr_{0.1}Y_{0.1}Yb_{0.1}O_{3-δ}, or a combination thereof, wherein δ is an oxygen deficit.

20. The method of claim 12, wherein introducing the hydrogen gas to the electrochemical cell comprises:
introducing the hydrogen gas to the electrochemical cell including the proton-conducting membrane comprising Ba₃(Sr₁₋ₓNb_{2-y}YₓYb_{y})O_{9-δ}, wherein x and y are dopant levels and δ is an oxygen deficit.
